(19) United States
(12) Patent Application Publication
(10) Pub. No.: US 2015/0130926 A1
(43) Pub. Date: May 14, 2015

(54) Method And Apparatus For Mapping And Analyzing Surface Gradients

(71) Applicant: Boulder Imaging, Inc., Louisville, CO (US)

(72) Inventors: Chris R. SHERIDAN, III, Boulder, CO (US); Carlos JORQUERA, Louisville, CO (US); Jie KULBIDA, Broomfield, CO (US); Colin ANDREW, Boulder, CO (US)

(73) Assignee: Boulder Imaging, Inc., Louisville, CO (US)

(21) Appl. No.: 14/079,343

(22) Filed: Nov. 13, 2013

(51) Int. Cl. G01N 21/88; G01N 21/85; G06T 7/00

(52) U.S. Cl. CPC G01N 21/8803; G06T 7/0008; G01N 21/85; G06T 2207/10004; G06T 2207/10141; G06T 2207/30108
USPC 348/128

(57) ABSTRACT

An apparatus and method is disclosed for analyzing a surface. An image capturing device (ICD) and a light source may be supported on a frame-like structure fixedly relative to each other. The light source may direct substantially parallel light rays at the surface at an angle β relative to the surface, which are reflected off of the surface as reflected light rays as the light source and the ICD are moved relative to the surface. The ICD has a view axis disposed at an angle a relative to the surface, and operates to capture only light rays that are reflected along angle α, which form an image. The image provides an indication of a characteristic of the surface.

### FIELD

The present teachings generally relate to a method and apparatus for mapping and analyzing a gradient of a surface. More particularly, the present teachings relate to various methods and apparatus for using light rays reflected from a surface to construct an image that represents variations in surface angle with a high spatial resolution. The present teachings include the algorithmic analysis of time image to determine one or more characteristics, features, anomalies or defects of the surface or particles that form a portion of the surface.

### BACKGROUND

This section provides background information related to the present disclosure which is not necessarily prior art.

Known methods for optically inspecting a surface for defects or topographical variations include aiming diverging or converging light rays from a conventional (non-collimated) light source at a working surface. Some portion of that light is directly reflected while some portion is scattered at other angles due to microscopic surface roughness. An image capturing device is then commonly positioned at an angle close, but not equal to, the nominal angle of the reflected light, such that the camera nominally captures the lower intensity scattered light. Gross changes in the local surface angle, as represented by the surface normal vector, can then cause the higher intensity reflected light to enter and be captured by the image capturing device. However, because the light source has some finite width, a multitude of light rays emitted from the non-collimated source (i.e., non-parallel light rays) will strike a given point on the working surface, each ray from a different angle. Therefore, there is also a multitude of angles of reflected light, each ray with a similar intensity. As such, areas of the inspection surface with minimally different surface angles reflect light of sufficiently equal intensity into the image capturing device, preventing these changes in surface angle from being detectable in the image. Only more drastic changes to the surface angle cause changes in the light intensity and are detected in the image.

This method of surface inspection is also highly sensitive to possible variations in the position of the working surface with respect to the camera and light. A positional translation of the working surface with respect to the light and camera changes the angular relationship between these three elements and consequently changes the intensity of the light captured by the camera. These changes in intensity can be indistinguishable from the changes caused by variation in the surface angle. This can mask or significantly hinder the detection of features or defects in the surface being analyzed.

This method of surface inspection has been previously employed in automated particle grind measurement equipment. Particle grind analysis is an important part of various manufacturing and testing processes. The size (or the fineness of grind) of particles in a ground material, such as pigment particles within a liquid, can affect numerous surface finish characteristics such as color uniformity, gloss, opacity and tint. The existing automated particle grind measurement equipment utilizes a solid rectangular gauged block with a flat top surface having at least one channel or groove of tapered depth machined therein, and is commonly referred to as a “Hegman gauge.” To perform an inspection, an operator puddles material samples into the deep side of the channels formed in a top surface end of the gauge. The machine then draws the samples down with a flat edge toward the shallow side of the channels of the gauge. The material fills the channels and the machine optically inspects the gauge in order to identify the location where a regular, significant “pepperiness” in the appearance of the coating can be found, using the optical inspection method previously described. This location determines the coarsest-ground, dispersed particles in the material sample. The shortcomings of the optical inspection method utilized can lead to inaccuracies in the calculated reading of fineness of grind.

### SUMMARY

This section provides a general summary of the disclosure, and is not a comprehensive disclosure of its full scope or all of its features.

In one aspect the present disclosure relates to an apparatus for analyzing a surface. The apparatus may have an image capturing device and a collimated light source supported on a frame-like structure fixedly relative to each other. The light source may direct substantially parallel light rays at the surface at an angle β relative to the surface, which are reflected off of the surface as reflected light rays. The image capturing device has a view axis disposed at an angle α relative to the surface. The image capturing device captures substantially only those ones of the reflected light rays that are reflected in accordance with the angle α, and which form an image. The image provides an indication of a characteristic of the surface.

In another aspect the present disclosure relates to an apparatus for analyzing a distribution of particles contained in a composition. The apparatus may comprise a body having a working surface upon which the composition to be analyzed is applied. A moveable frame-like structure may include an image capturing device and a light source for reflecting light off of the composition. The image capturing device has a view axis disposed at an angle α relative to the working surface. The light source produces an image from light reflected off of the composition. The image includes a plurality of substantially parallel light rays disposed at an angle β relative to the working surface, which is useable to create a histogram indicative of a fineness of a grind of the composition.

In still another aspect the present disclosure relates to a method of analyzing a surface. The method may comprise moving an image capturing device having a collimated light source from a first position to a second position, at an angle β relative to the surface, to illuminate the surface with a plurality of parallel light rays. The method may further involve simultaneously moving an image capturing device, arranged with a view angle at an angle α which is different from the angle β, over the surface to capture light rays which are reflected from the surface, the light rays forming an image. The image may be used to analyze the gradient of the surface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an apparatus for detecting surface gradients in accordance with the teachings of the present disclosure.

FIG. 2 is a perspective view of one embodiment of the apparatus of FIG. 1, but with the apparatus shown without a holder component.

FIG. 3 is a side view of the apparatus of FIG. 1, with a camera and a light generating system shown in a first position.

FIG. 4 is another side view of the apparatus of FIG. 1 but with the camera and the light generating system shown in a second position.

FIG. 5 is a perspective view of a surface analysis assembly of the apparatus of FIG. 1, with the surface analysis assembly shown removed from the remainder of the apparatus for purposes of illustration.

FIG. 6a is a high level diagram illustrating how light rays generated by the light generating system are reflected from the surface at generally the same angle (α), relative to the surface, that they impinge the surface (angle β), except for those light rays that are reflected by microscopic or larger surface features that project from the surface, which are reflected at an angle that differs from the angle α, and which may be reflected co-incident with angle δ, which is the angle at which the image capturing device is aligned relative to the surface.

FIG. 6b shows how change in the angle of reflection of the light rays of the system of FIG. 6a may be detected when a pit or depression is present, which cause an increased percentage of the reflected light rays to be reflected along the image capturing axis and captured by the image capturing device, thus producing a significantly increased image intensity.

FIG. 6c is a schematic representation that illustrates the system of 6a and how minor changes in the distance “D” between the working surface and the light source do not cause a change in the angle of the reflected rays, and thus do not substantially change the percentage of reflected rays that are received by the image capturing device.

FIG. 6d is a high level block diagram of one example of a system for use with the apparatus of FIG. 1 for acquiring and analyzing the data necessary to make a Hegman reading.

FIG. 6e is an example histogram which may be produced from the images obtained by the image capturing device.

FIG. 7a is a block diagram showing the general steps of a method for detecting particle dispersion in accordance with the teachings of the present disclosure.

FIG. 7b is a block diagram further detailing the process image operation of the method for detecting particle dispersion of FIG. 7a.

FIG. 7c is a block diagram further detailing the process channel of FIG. 7b.

FIG. 7d is a block diagram further detailing the compute Hegman Reading from remaining blobs of FIG. 7c.

FIG. 7e is a block diagram further detailing an operation called for in FIG. 7d.

Corresponding reference numerals indicate corresponding parts throughout the several views of the drawings.

### DETAILED DESCRIPTION

Example embodiments will now be described more fully with reference to the accompanying drawings.

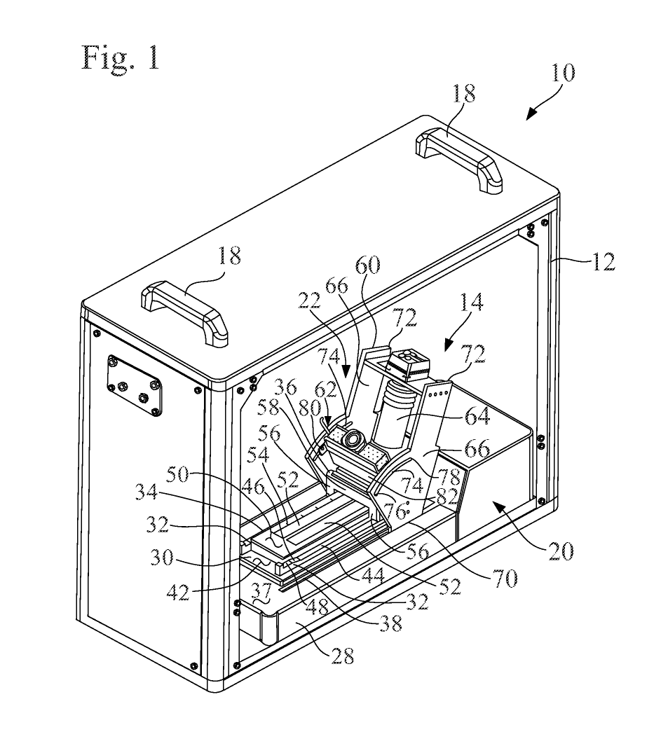

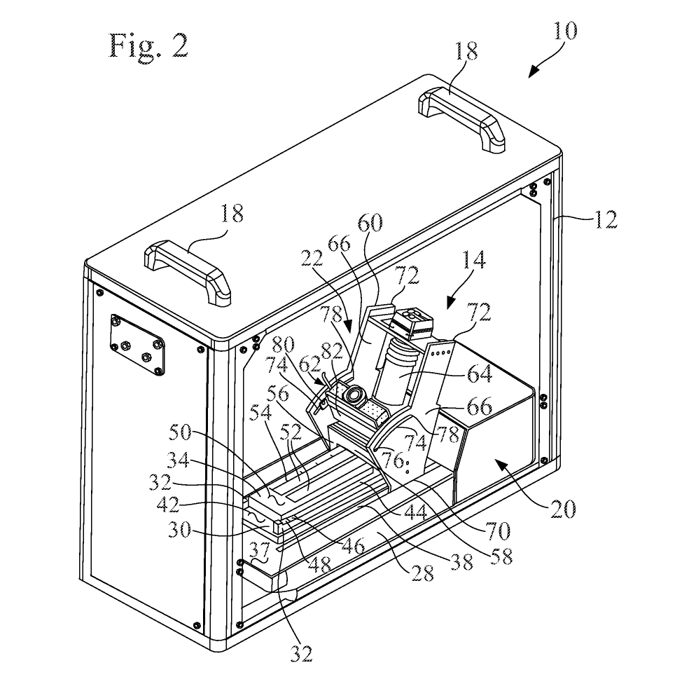

With general reference to FIGS. 1 through 5 of the drawings, one embodiment of an apparatus 10 is disclosed for analyzing the gradients or angles of a surface, or a coating or composition that is present on a substrate or support surface. In one particular application to be described in detail in the following paragraphs, the apparatus 10 is used to detect and analyze the fineness of grind of particles in a composition, in one specific example the particles making up pigment in a liquid such as paint. The apparatus 10 may be used to enable an objective analysis of the characteristics and quality of a surface finish in a repeatable manner. By way of example only, the apparatus 10 may be used to determine and analyze the relative size of titanium dioxide particles in a sample of paint. The apparatus 10 may also be used to detect the size of any ground particle in a fluid carrier material. The significantly increased sensitivity of the apparatus 10, as well as its significantly improved signal-to-noise ratio performance, also enables it to be used to more generally detect microscopic changes in one or more gradients of a surface, as could be caused by microscopic bumps, cracks, pits, elevated ridges or other surface features, just to name a few. When mapped onto an image, the dimensions, locations and shapes of such features can be viewed and analyzed. The apparatus 10 may be used to detect the grind of particles in any of a wide variety of different compositions, for example a composition having a consistency of a paste, a gel or a liquid. The apparatus 10 may also be used to inspect a surface, for example a panel, to detect the presence, location and size of contaminants (e.g., particles, hair, etc.) that may be present on a surface or in a coating on the surface.

As illustrated in FIG. 1, the apparatus 10 in one embodiment may be configured as a stand-alone, portable unit to analyze the fineness of grind of particles in a composition. The apparatus 10 may interface with a user's computer, for example a laptop or desktop. In other embodiments the apparatus 10 may be configured to integrally include the requisite computing equipment or processor.

The apparatus 10 may generally include an enclosure or housing 12 to facilitate portability and otherwise protect the apparatus 10 during transportation. The apparatus 10 may also generally include an analysis assembly 14. The housing 12 may be a generally hollow construct having at least one access location or door (not shown) for accessing an interior portion of the housing 12 (including the analysis assembly 14). The housing 12 may also include at least one handle 18 for transporting or otherwise moving the apparatus 10. In one configuration the housing 12 may be a rectangular box or cuboid having two (2) handles 18 and a hinged door.

With continued reference to FIGS. 1 through 5 of the drawings, the analysis assembly 14 of the present disclosure will be further described. As illustrated, the analysis assembly 14 may include a first or base subassembly 20 and a second or carriage subassembly 22. As will be appreciated below, the carriage subassembly 22 is adapted to translate relative to the base subassembly 20.

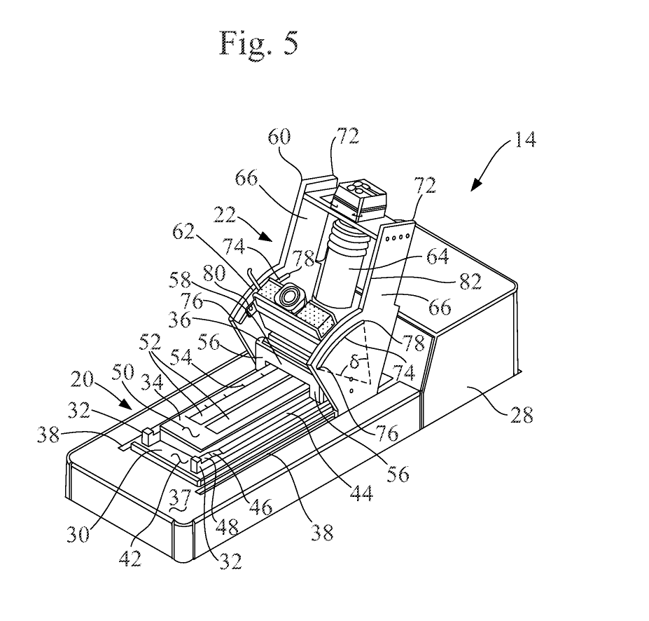

The base subassembly 20 may generally include a base 28, an inspection block 30, at least one rail member 32, a body or gauge block 34, and a holder 36. The base 28 may be mounted within the housing 12. The base 28 may include a first support surface 37 and at least one slot 38 extending across the surface 37. As illustrated in FIG. 5, in one configuration the surface 37 may include two (2) substantially linear, parallel slots 38.

The inspection block 30 may be a generally rectangular member having a second support surface 42. The inspection block 30 may be mounted to the base 28 such that the second support surface 42 is generally parallel to the first support surface 37 of the base 28. While the inspection block 30 is generally shown as a unitary piece, it is also understood that the inspection block may be formed from a plurality of distinct layers of material, such as a stack of shims. The inspection block 30 may be mounted to the base 28 using mechanical fasteners (e.g., screws), adhesive or other suitable fastening techniques. As illustrated, the inspection block 30 may be mounted between the slots 38.

The rail member 32 may include a first surface 44, a second surface 46 and a third surface 48. The second surface 46 may angularly extend from and between the first surface 44 and the third surface 48 to form a ramp between the first and third surfaces. The first, second and third surfaces 44, 46 and 48, respectively, may be substantially planar. The first surface 44 and the third surface 48 may be substantially parallel to the second support surface 42 of the inspection block 30. In one configuration, the base subassembly 20 may include two (2) substantially parallel rail members 32 located between the slots 38. The rail members 32 may be mounted to the inspection block 30 using mechanical fasteners (e.g., screws), adhesive, or other suitable fastening techniques, or may even be machined from material making up the inspection block such that the rail members 32 form an integral part of the inspection block 30.

The gauge block 34 may be a solid rectangular block of material having a working surface 50, and is commonly known as a grindometer block or a “Hegman gauge block”. It will also be appreciated that the gauge block 34 may be any other type of body or structure having a working surface that is subject to surface inspection. The working surface 50 may be a substantially planar upper surface (relative to FIG. 1) of the gauge block 34. One suitable gauge block 34 for use with the apparatus 10 of the present teachings is commercially available from BYK-Gardner, a division of Altana AG.

The planar working surface 50 may include at least one linear channel 52 machined or otherwise formed therein and generally tapered in depth along its length such that the depth changes uniformly from one end of the channel 52 to the other. While the gauge block 34 may optionally include metering or calibration marks 54 along the length of the channel 52. In one configuration the gauge block 34 includes two (2) substantially parallel channels 52. The gauge block 34 may be removably located on the inspection block 30 between the rail members 32.

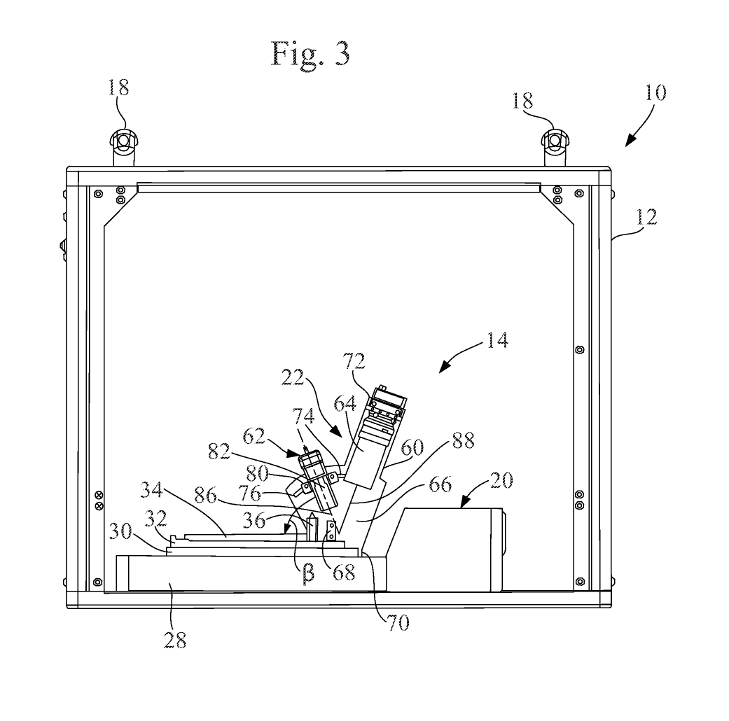

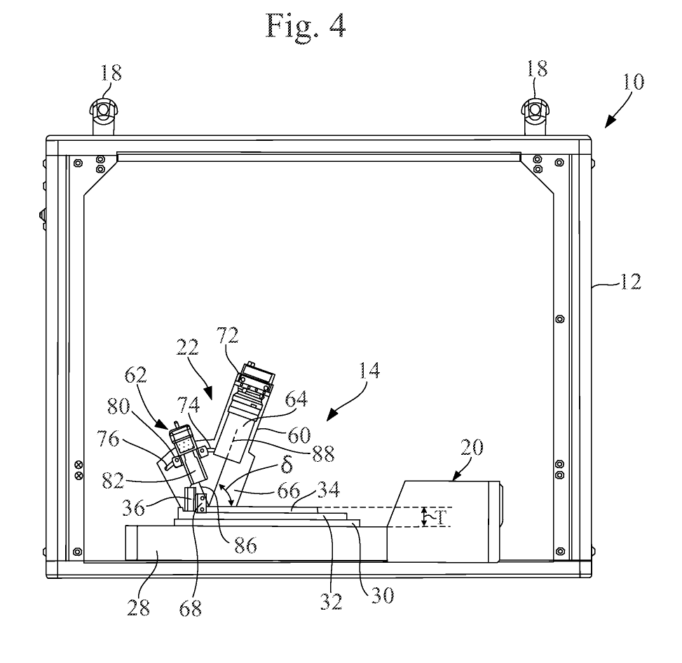

The scraper 36 may include at least one leg portion 56 and a blade portion 58. In one specific configuration the holder 36 may include two leg portions 56, with the blade portion 58 extending there between. The holder 36 may be removably assembled or placed on the base subassembly 20 such that the leg portions 56 are supported on the rail members 32. The carriage subassembly 22 is conventionally mounted for linear movement relative to the base subassembly 20. In this regard the carriage subassembly 22 is moveable linearly from a first position to a second position. The first position is shown in FIG. 3 and the second position is shown in FIG. 4.

The carriage subassembly 22 may include a bracket 60, a light assembly 62 and an image capturing device 64. The bracket 60 may include at least one leg 66 and at least one bumper 68. In one configuration the bracket 60 includes two substantially parallel legs 66.

With particular reference to FIG. 3, the bumper 68 may be mounted to, and extend between, the legs 66. The bumper 68 is operable to contact the holder 36. Each leg 66 may define a first end 70 and a second end 72, and may include a generally arcuate slot 74 formed between the first end 70 and the second end 72. The first end 70 of each leg 66 may be slidably or otherwise moveably mounted to a corresponding track (not shown) or similar support portion of the base subassembly 20. Each leg 66 may extend through its corresponding slot 38 formed in the surface 37 of the base 28. The arcuate slot 74 may extend from a first end 76 to a second end 78, thereby enabling the light assembly 62 to be located at a central angle α between about 60 degrees and about 89 degrees (FIG. 5) relative to the working surface 50 of the gauge block 34, allowing calibration between the angular position of the light assembly 62 and the image capturing device 64. The center point of the radius of the arcuate slot 74 is coincident with the line where the image capturing device 64 is focused such that angular positioning adjustments to the light assembly 62, along the arcuate slot 74, do not affect the location on the working surface 50 where the light assembly 62 is aimed. In one exemplary configuration the angle α may be substantially equal to 70.8 degrees.

The light assembly 62 may include at least one mount portion 80 and a light source 82. The light assembly 62 may be mounted to the bracket 60. Specifically, the mount portion 80 of the light assembly 62 may be mounted within the arcuate slot 74 such that the mount portion 80 is operable to slide, or otherwise move within, the arcuate slot 74 from the first end 76 to the second end 78. In this regard the mount portion 80 may be a rod, pin or other suitable structure for operably engaging in and traversing the arcuate slot 74. This enables the angle of the light rays emitted from the light assembly 62 to be adjustably positioned relative to the working surface 50.

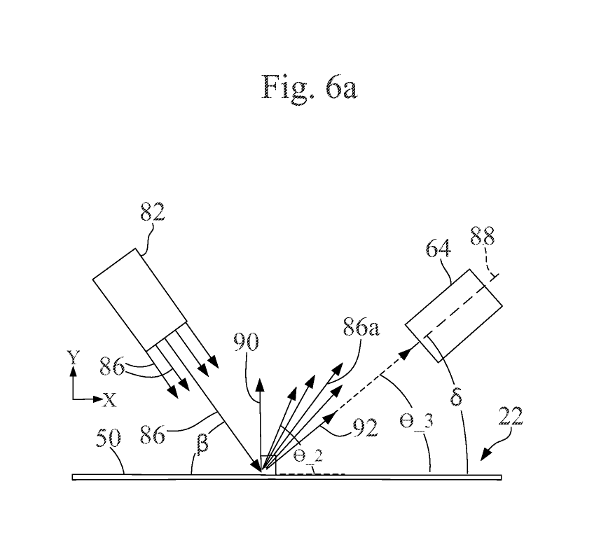

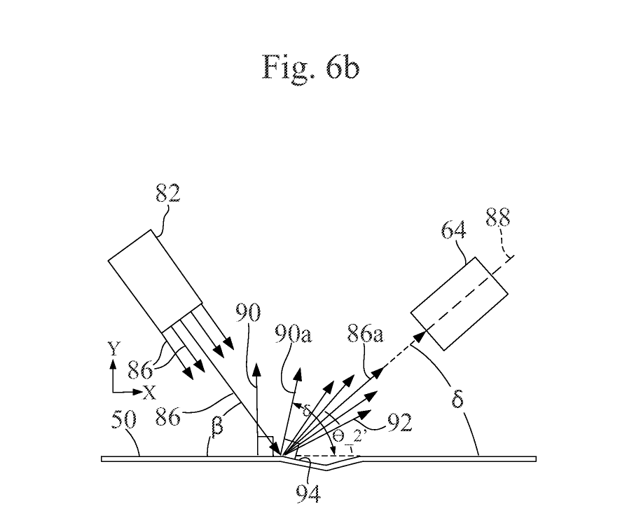

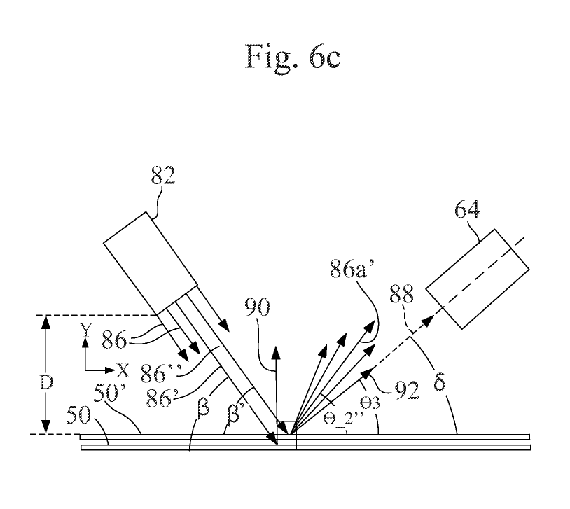

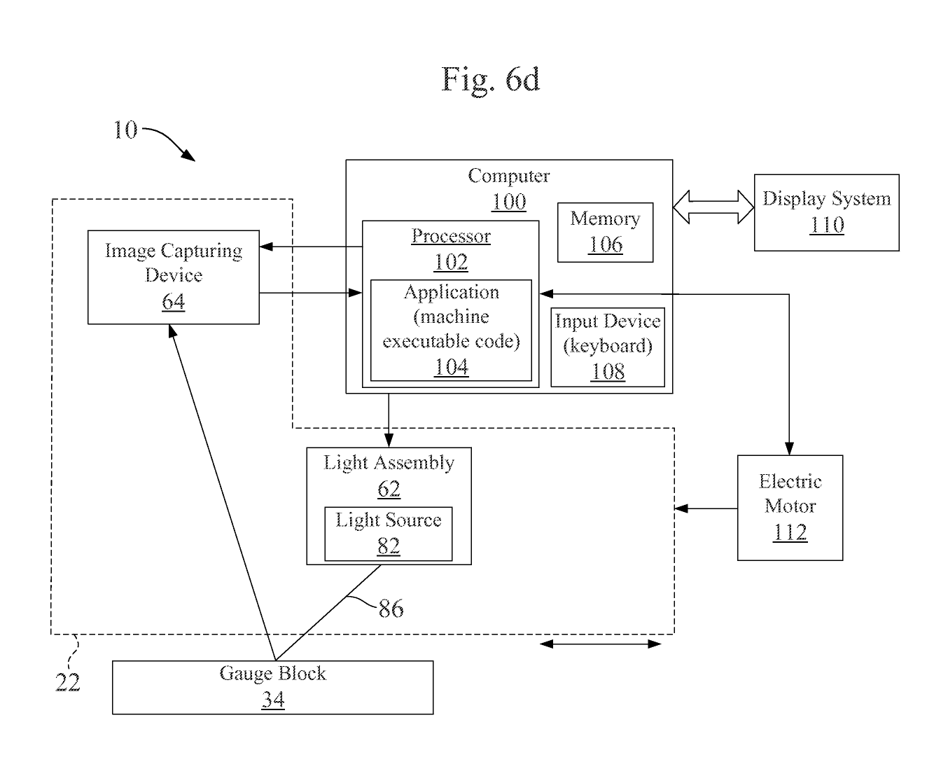

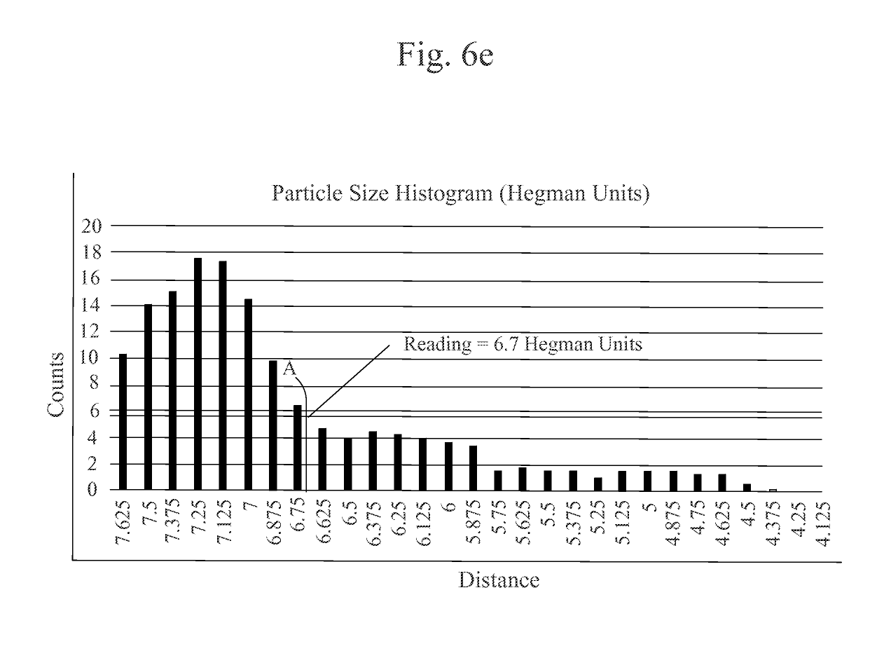

The mount portion 80 may be fastened to the light source 82. The light source 82 may be generally located between the legs 66 of the bracket 60 and above the gauge block 34. The light source 82 may be operable to project a plurality of parallel light rays that cooperatively form a beam or “light profile.” The light profile may be a substantially uniaxially collimated light profile generating approximately parallel light rays 86 (FIG. 4). The light rays 86 leaving the light source 82 contact the working surface 50 at an angle β (FIG. 3) in the X-Y plane, relative to the working surface 50 (FIG. 6a). As will be described in more detail below, the use of a substantially collimated light profile (i.e., collimated light beam) ensures that small changes or inconsistencies (e.g., a particle or a defect) present in the plane of the working surface 50 are easily detected by the image capturing device 64, further ensuring the calculation of an accurate Hegman reading. The use of a substantially collimated light profile also ensures that the intensity of the images collected by the image capturing device 64 will not be substantially affected by small variations in the height of the working surface 50. This reduced sensitivity to a potentially confounding variable helps to ensure the calculation of an accurate Hegman reading even when a thickness T (FIG. 4) of the gauge block 34 (i.e., distance between the light source 82 and the material sample) varies slightly.

When the mount portion 80 of the light assembly 62 is located at the first end 76 of the arcuate slot 74, the angle β between the light rays 86 and the working surface 50 may be substantially equal to 58.8 degrees, for example. When the mount portion 80 of the light assembly 62 is located at the second end 78 of the arcuate slot 74, the angle β may be substantially equal to 78.8 degrees, for example. As illustrated in FIG. 3, in one particular configuration the light source 82 may be mounted to the bracket 60 such that the angle β is substantially equal to 68.8 degrees.

The image capturing device 64 may be a video camera, a still frame camera, or any other suitable device for capturing and transmitting images. In one particular configuration the image capturing device 64 is a line scan video camera designed to accept incoming light rays only at a single angle δ in the x-y plane. The image capturing device 64 may be mounted to and carried by the bracket 60. In one configuration the image capturing device 64 may be mounted proximate to the second end 72 of the bracket 60.

With brief reference to FIGS. 4 and 6a, a lens (not shown) of the image capturing device 64 may be aimed relative to the working surface 50 of the gauge block 34 such that an image capturing axis 88 of the image capturing device 64 is incident on the working surface 50 at the angle δ. The angle δ may be between approximately 15 degrees and 85 degrees. While the image capturing device 64 is generally shown in a fixed configuration relative to the bracket 60, it is also understood that the image capturing device 64 may be rotatably mounted to the bracket 60 such that the angle δ is adjustable. As illustrated in FIG. 4, in one particular configuration the angle δ is substantially equal to 70.8 degrees relative to the working surface 50.

The image capturing device 64 may be operable to send and receive images comprising image data to a computing device (not shown) via a wired or wireless data transmission method. In this regard the computing device may include an output device (e.g., a display or monitor), an input device (e.g., a keyboard, mouse, USB port, Bluetooth receiver), and a memory system (e.g., hard drive or RAM), and may be integrated into the apparatus 10. In another configuration the apparatus 10 may be a stand-alone apparatus for detecting particle dispersion which is operable to communicate with a separate, stand-alone computing device via software or another program running on the computing device.

Referring now to FIGS. 6a-6c, the process of analyzing the images obtained from the image capturing device 64 will be described. However, it will be appreciated that while the following discussion pertains to the example of analyzing images obtained using a Hegman gauge, that the teachings presented herein are not limited to use with only Hegman gauge applications. The teachings described in connection with FIGS. 6a-6c may just as readily be used to analyze images of any form of planar surface where one needs to determine a roughness, coarseness, texture, granularity, or one or more gradients of the surface, or to detect and map one or more gradients of the surface, or to detect various features (e.g., pits, bumps, cracks, elevated ridges, crevasses, etc.) in a surface.

In this example a liquid composition making up a test sample, such as pigment suspended in a carrier liquid, may be added to the working surface 50 and/or to the at least one channel 52 of the gauge block 34. The composition will typically include particles of various sizes that are suspended within the liquid of the composition. An electric motor (not shown) or other suitable power source may cause the carriage subassembly 22 to move from a first position (FIG. 3) to a second position (FIG. 4) relative to the gauge block 34. Specifically, the legs 66 of the bracket 60 may move in a first direction relative to the track (not shown) and within the slots 38 of the base 28. As the carriage subassembly 22 moves in the first direction, the bumper 68 may cause the holder 36 to move in the first direction, thereby pushing the blade portion 58 over the working surface 50 of the gauge block 34 and over the tops of the channels 52, which have been filled with the liquid composition. The blade portion 58 will effectively “clean” the upper surfaces of the particles that protrude above the plane of the working surface 50 so that they are visible in the composition. The image capturing device 64 may capture images of the working surface 50, including the channels 52, as the carriage subassembly 22 is moving in the first direction, and electronically transmit the images to the computing device (not shown) for storage in the memory for later retrieval, viewing and analysis. The carriage subassembly 22 may urge the holder 36 up onto the second surfaces 46 of the rail members 32 until the blade portion 58 is no longer contacting the working surface 50 when the holder 36 reaches the opposite end of the gauge block 34.

After the carriage subassembly 22 reaches the second position (FIG. 4), the electric motor may cause the carriage subassembly 22 to move in a second direction, opposite to the first direction, back to the first position (FIG. 3). While the image capturing device 64 is described herein as capturing images of the working surface 50 while the carriage subassembly 22 is moving in the first direction, it is also understood that the carriage subassembly 22 may capture images of the working surface 50 while the carriage subassembly 22 is moving in the second direction.

As illustrated in FIG. 6a, while the carriage subassembly 22 is moving between the first position and the second position, the emitted collimated light rays 86 may reflect from the working surface 50 as reflected light rays 86a. When the light rays 86 reflect from a horizontal portion of the working surface 50, the majority of the reflected light rays 86a reflect at a principal reflection angle θ2 in the x-y plane. The principal reflection angle θ2 is substantially equal in magnitude to angle β of the light rays 86, but symmetric to the normal 90 of the working surface 50. A significantly smaller portion of the reflected light rays 86a reflect at other angles due to smaller scale surface roughness, such as reflected light ray 92, which reflects at angle θ3 in the x-y plane. Angle θ3 may be substantially equal to angle δ of the image capturing axis 88. As such, the intensity of the light rays detected by the image capturing device 64 may be represented by a first magnitude which is substantially less than the intensity of light rays 86 emitted from the light assembly 62 because only a small portion of the emitted light rays 86 are reflected at the necessary angle (i.e., δ) to be detected by the image capturing device 64. It is these reflected light rays that are reflected at the necessary angle of δ that form the image captured by the image capturing device 64.

As another example, in FIG. 6b when the light rays 86 reflect from an example non-horizontal portion 94 (e.g., a depression, pit, projecting blob or other defect) of the working surface 50, the majority of the reflected light rays 86a may reflect at a principal reflection angle θ2′ in the x-y plane. The principal reflection angle θ2′ may be substantially equal to the angle δ. As a result, a much greater percentage of the emitted light rays may be reflected along the image capturing axis 88 that the image capturing device 64 is focused on. Accordingly, the image(s) captured by the image capturing device 64 in FIG. 6b may have a much higher light intensity than the image captured by the image capturing device 64 in FIG. 6a. Thus, it will be appreciated that by using a collimated light source, even an extremely small change in the angle that the light rays are reflected from the substantially planar, horizontal working surface 50 will result in a substantial increase or decrease in the percentage of the light rays reflected into the image capturing device 64, and thus the intensity of the image(s) obtained. This effectively enables the image capturing device 64 to monitor for an expected “band” or range of image intensity from the reflected light rays, and when the intensity is above or below this predetermined band or range, these out-of-band intensity variations can be used to indicate changes to the surface gradient or angle. Specifically, the use of a substantially collimated light profile is expected to provide significantly enhanced sensitivity with which to detect and locate particles present in a composition, as well as to provide significantly enhanced sensitivity to and detection of microscopic bumps, pits, cracks, ridges or other surface abnormalities or contaminants on the working surface 50.

Another advantage of the apparatus 10 is that it can be configured to be substantially insensitive to small changes in overall thickness or elevation of the working surface 50. This is illustrated in FIG. 6c, which shows a distance D between the working surface 50 and the light source 82 which changes in the y-direction. In FIG. 6c the light rays 86 leaving the light source 82 may contact the working surface 50′ at an angle β′ in the X-Y plane, relative to the working surface 50′. The angle β′ may be similar to the angle β (FIG. 6a). When the light rays 86 reflect from a horizontal portion of the working surface 50′, the majority of the reflected light rays 86a′ will reflect at a principal reflection angle θ2″ in the x-y plane. The principal reflection angle θ2″ is equal in magnitude to angle β′, but symmetric to the normal 90 of the working surface 50′. A smaller portion of the reflected light rays 90 may reflect at angle θ3′ in the x-y plane. Angle θ3′ may be substantially equal to angle δ of the image capturing axis 88. Accordingly, the apparatus 10 is operable to accurately analyze a surface when the distance D between the working surface 50 and the light source 82 changes in the y-direction. In one specific application this feature may be used to compensate for a change in the thickness T (FIG. 4) of the gauge block 34 of a Hegman gauge. This is because the collimated light rays 86 will still be reflected at the same principal reflection angle θ2 regardless of minor variations in the distance D. As such, the apparatus 10 is substantially insensitive to minor variations in the thickness or small elevational changes of the surface being analyzed. This feature is expected to be particularly useful when the apparatus 10 is being used in connection with the gauge block (i.e., Hegman block), where changes in the thickness of the gauge block would otherwise be expected to significantly affect the intensity of a reflected light signal from a non-collimated sight source, and thus potentially significantly influence the images being obtained by the image capturing device 64.

The apparatus 10 is further shown in one specific configuration in FIG. 6d. The apparatus 10 in one embodiment may include a suitable computer 100, for example a PC, laptop or any other form of electronic device having the necessary computing power and interface to communicate with the various components of the apparatus 10. The computer 100 may include a processor 102 that runs a suitable application 104 (machine executable code) for analyzing and interpreting the data generated by the image capturing device 64, as well as helping to control motion of the carriage subassembly 22 and operation of the light assembly 62. A memory 106 may be employed for storing the application 104 and/or the results of the data acquisition and analysis performed by the apparatus 10. An input device 108, for example a keyboard and mouse, may be provided to enable the user to control and use the apparatus 10. A display system 110 may be used to display the results of the data acquisition and analysis performed by the apparatus 10. The processor 102 may also be used to control operation of a motor 112 to cause sequencing back and forth translation of the carriage subassembly 22 in accordance with operation of the image capturing device 64 and the light assembly 62. It will be appreciated that the configuration shown in FIG. 6d could be modified significantly with other components that perform the needed control operations, and that the illustration of FIG. 6d shows merely one example of a suitable control system for controlling the components of the apparatus 10.

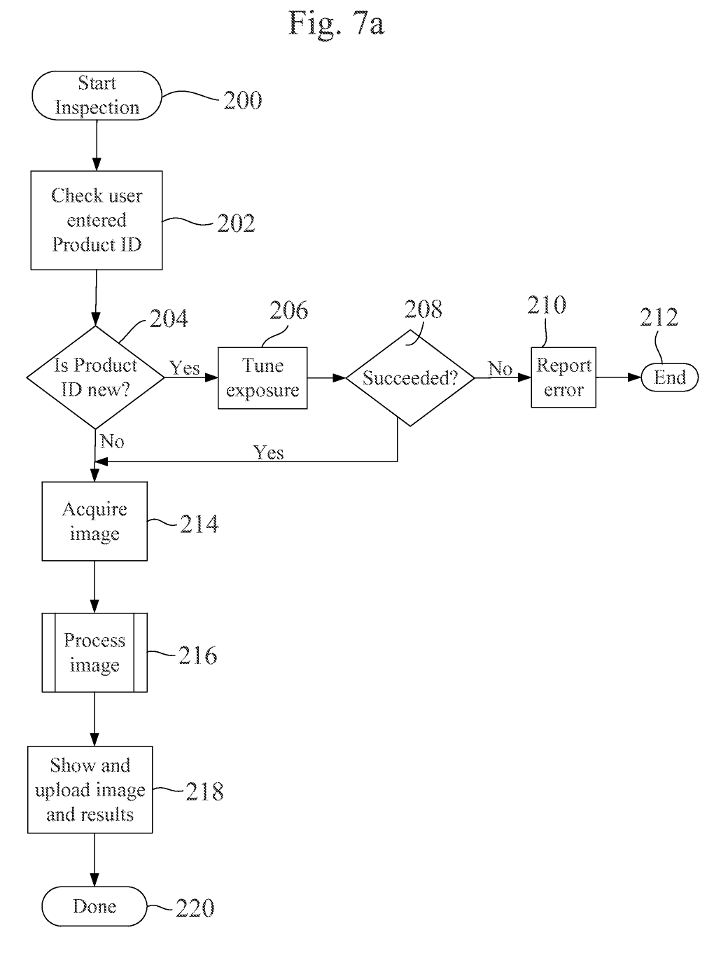

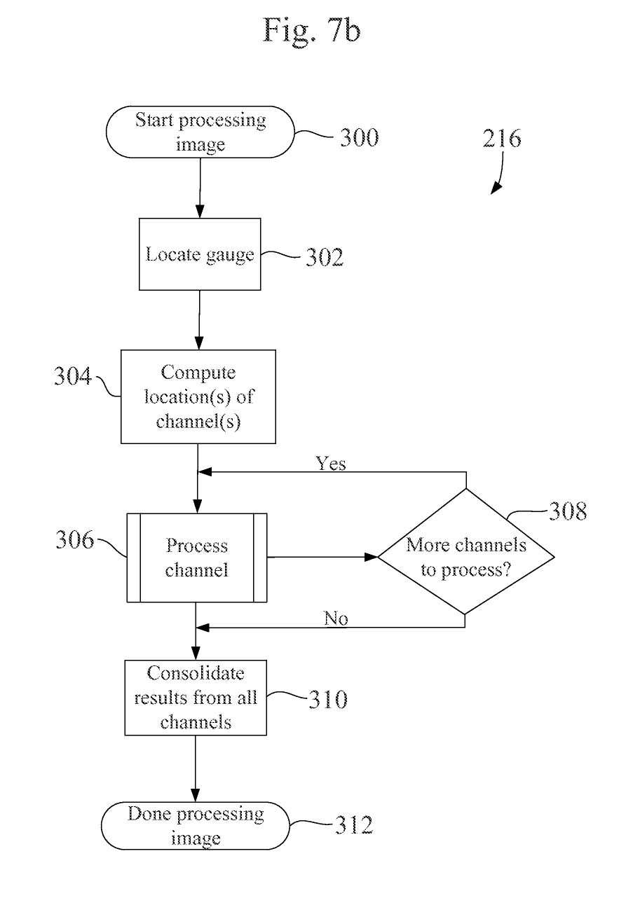

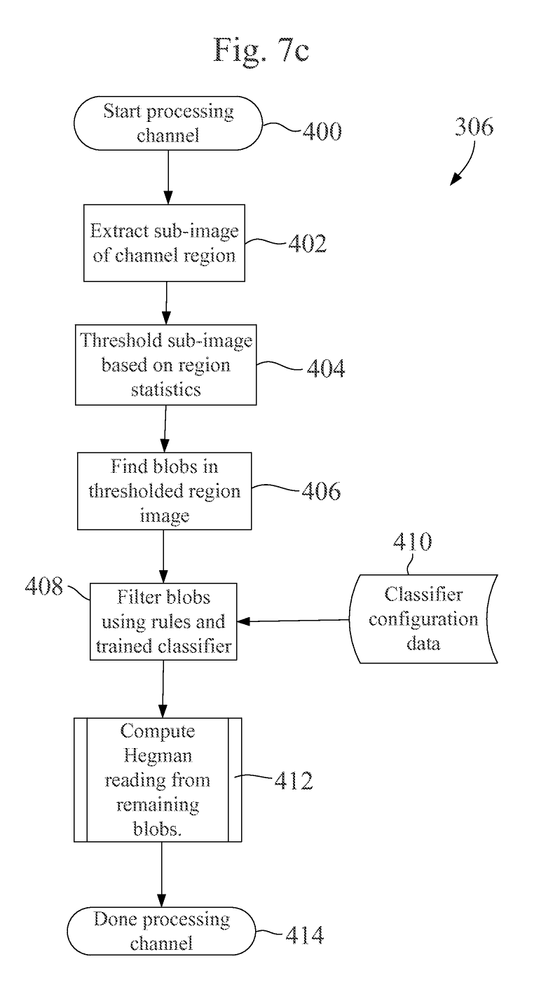

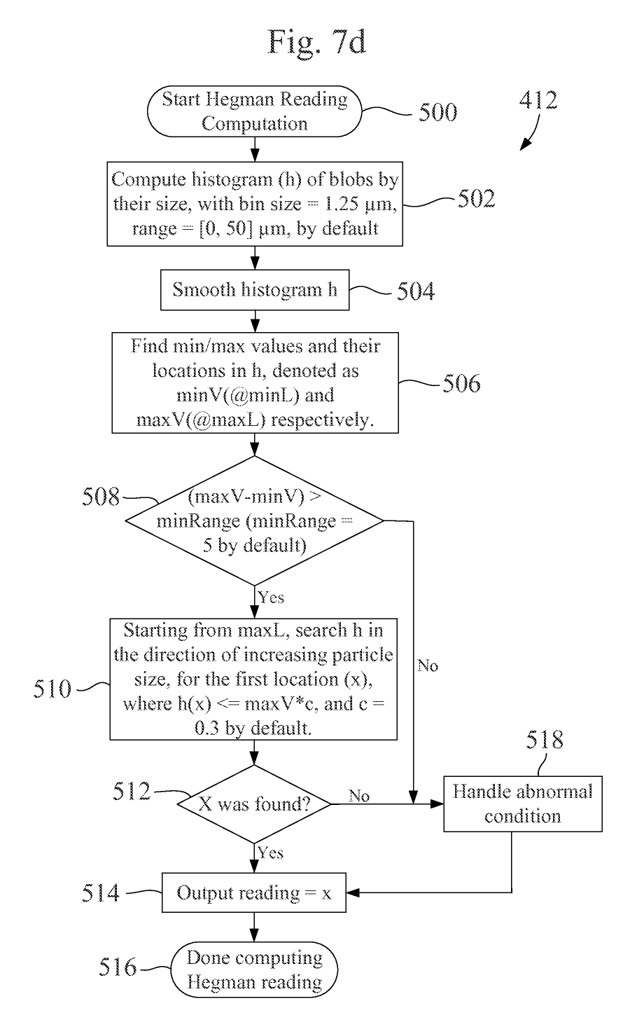

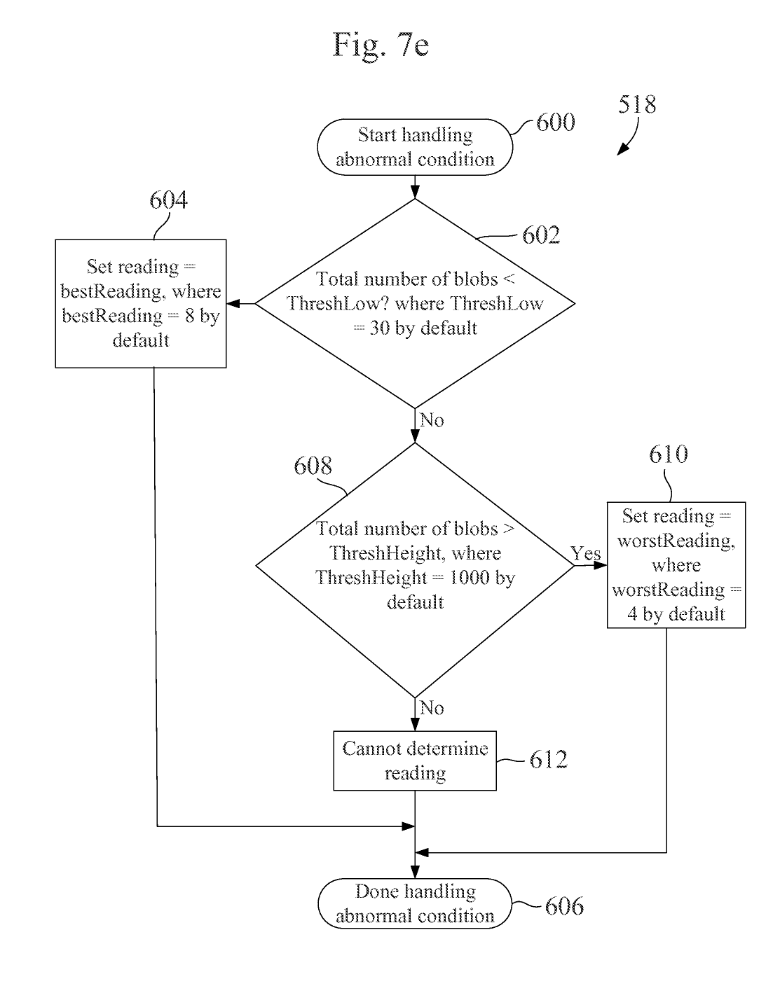

With continued reference to FIGS. 1 through 6c and additional reference to FIGS. 7a through 7e, a method in accordance with the present disclosure for detecting and mapping one or more surface gradients will be discussed. In this particular example the apparatus 10 is used to detect and map particle distribution in a liquid composition. Again, it will be appreciated that while the following description presented in FIGS. 7a through 7e focuses on the application of obtaining a Hegman reading using a Hegman guide, the operations described in FIGS. 7a-7e could be used with little or no modification in determining one or more surface gradients, or a coarseness, roughness, texture or granularity of any generally planar surface, as well as detecting surface features (bumps, pits, ridges, cracks, crevasses) or abnormalities. Therefore the system and method of the present disclosure is not limited to only applications involving a Hegman guide. The method begins at operation 200—Start Inspection. At this operation the apparatus 10 is connected to power and connected to the computing device (e.g. computer 100 in FIG. 6d).

At operation 202 the computing device checks the product identification entered by the user, and proceeds to decision block 204. If the product identification is a new product identification, the method proceeds to operation 206 at which the exposure is tuned or calibrated. By “tuned” it is meant that an optimal amount of exposure time for the image capturing device 64 is obtained by an iterative process involving increasing or decreasing the exposure time based on the deviation of the current average pixel intensity value from a desired pixel intensity value. The purpose of the tuning process is to ensure that the sensors of the image capturing device 64 operate within a desirable range for samples of varying reflectance, and therefore maximize their signal-to-noise ratio. At operation 208 a check is made if the tuning operation was successful and, if not, the method proceeds to operation 210 and issues a report error of the exposure. Upon such failure, the method proceeds to end at operation 212.

If the tune exposure operation is detected at operation 208 as having been successful, then the method advances to operation 214. Similarly, if it is determined at operation 204 that the product identification is not new, the method advances to operation 214. In this case the computing device defers to saved data concerning tuning exposure for the existing product identification.

After the image is acquired at operation 214 it is processed at operation 216. Acquiring the image at operation 214 may involve a pass of the carriage subassembly 22 in one direction or it may involve movement of the carriage fully in one direction and then fully in the opposite (i.e., return) direction. The image processing of operation 216 is further detailed at FIG. 7b. At this operation the images captured by the image capturing device 64 are processed and analyzed by the processor computer 100. At operation 218 the image and results generated by the computer 100 may be uploaded to memory 106 and/or presented on the display system 110 for display to the user. The method is thus concluded at operation 220.

The image processing indicated at operation 216 in FIG. 7a is shown in greater detail in FIG. 7b. Referring to FIG. 7b, at operation 300 the image processing is initiated. At operation 302 the gauge block 34 is located. This is done to limit subsequent processing to the gauge region only for efficiency purposes, as well as to precisely derive the locations of the markers on the gauge. After the gauge block 34 is located, the method proceeds to operation 304 where the location(s) of the channel(s) (channels 52 in FIG. 5) is/are determined. This is useful for localizing the particle detection to the channel regions only, and allows for obtaining even more accurate readings. Thereafter, the method proceeds to operations 306 and 308 where the channel(s) is/are processed. Operation 306 is further detailed in FIG. 7c. Essentially, however, operation 306 involves detecting particles and subsequently computing the readings based on particle distribution in each channel, assuming for this example that there are two channels in the gauge block 34. At operation 310 the results from operations 306 and 308 are consolidated from all the detected channels by the processor 102. Processing of the image is thus completed at operation 312.

Referring to FIG. 7c, the channel processing of operation 306 is shown in greater detail. The channel processing is initiated at operation 400. Here, a first channel 52 is processed is processed. An initial operation 402 involves extracting a sub-image of the channel region for the first channel 52. At operation 404 a thresholded sub-image is generated based on region statistics. Such statistics include the mean and standard deviation of an edge magnitude image computed from the smoothed intensity image. A threshold is computed as (mean+delta*standard-deviation), where delta is an adjustable sensitivity coefficient (typically set at 3). A lower value in delta corresponds to higher sensitivity, which leads to more subtle particles being detected. At operation 406 blobs are identified in the threshold image region. By “blobs” it is meant protrusions or clumps of material that alter the flatness of the working surface 50. The blobs are computed by linking connected foreground pixels of the binary image resulting from the thresholding operation 404. At operation 408 the blobs are filtered using rules and a trained classifier. Classifier configuration data may be obtained at operation 410 for this purpose. Classification configuration data is generated from a training processing in which experienced experts will label a detected artifact as either a pigment particle or of other classes. The classification process allows the processor 102 and its executable code (i.e., software) to compute the reading using only the pigment particles and ignore other artifacts, such as air bubbles, dust, etc.

After the blobs identified in operation 406 are filtered in operation 408, the method proceeds to compute Hegman-type readings for the remaining blobs at operation 412. Operation 412 is further detailed in FIG. 7d. The processing of the channel under consideration is then completed at operation 414.

Referring to FIG. 7d, the Hegman reading computation 412 is shown in greater detail. The Hegman reading computation is initiated at operation 500. At operation 502 the computing device may create a histogram of the frequency in which particularly sized particles, agglomerates, grits, blobs, or scats appear in each image, relative to the location of each particle in the first channel 52. The histogram computed at operation 502 is preferably smoothed at operation 504 to allow more robust computation of the reading. Without smoothing, various drawdowns of the same sample could yield vastly different histograms, especially when the particle density is low. After smoothing, these differing histograms tend to converge to a more similar profile, which therefore leads to more consistent computation of the readings.

Once the histogram has been generated and smoothed, at operation 506 the computing device can determine the relative location of the particle size P1 with the highest count (denoted as “maxV” (@max L)) and the particle P2 (P2>P1) with the lowest count (denoted at “minV” (@minL)) in the histogram. Merely for purpose of illustration, an example histogram is shown in FIG. 6e. At operation 508 the computing device can determine the difference Δ between the frequency of occurrence maxV of the highest particle count P1, and the frequency of occurrence minV of the lowest count particle P2. More specifically, the Y-axis of the histogram illustrates the particle counts for differently present particle sizes, as well as the disparity in counts between particles of different sizes. The difference computed is actually the disparity in counts, that is, the count of the most frequently appearing particle size minus the count of the least frequently appearing particle size (usually 0).

If the difference Δ is greater than a predetermined range (e.g., 5), the method proceeds to operation 510 at which the computing device can analyze the histogram. The analysis involves analyzing the histogram in the direction of increasing particle size for the first encounter of location X3, where a frequency of occurrence V3 of a particle size P3 is less than or equal to a predetermined factor or percentage (e.g., 30%) of the frequency of occurrence maxV of the highest count particle P1. In FIG. 6e this point is denoted by reference letter “A”.

At operation 512 a check is made if a location was found where the particle meets the constraints imposed at operation 510. If this inquiry produces a “Yes” answer, then at operation 514 the computing device outputs the location (x), also referred to as the Hegman reading, to the output device. In the example histogram of FIG. 6e, location corresponds to about 6.7, or in other words 6.7 Hegman units. At operation 516 the Hegman reading computation is concluded.

If the difference Δ is determined at decision block 508 to be less than the predetermined range (e.g., 5), or if the computing device is unable to determine the location of a particle size that meets the conditions imposed at operation 510, then the computing device may proceed to operation 518 for the handling of abnormal conditions.

Referring to FIG. 7e, the various sub-operations performed at operation 518 will are further detailed. In FIG. 7e the handling of the abnormal condition is initiated at operation 600. At operation 602 a determination is made if the total number of particles (i.e., blobs) in the histogram is less than a first predetermined quantity (e.g., a “ThreshLow” value of 30). If the answer is positive, then at operation 604 the computing device may set the Hegman reading to a predetermined “best reading” default value (e.g., 8) and the abnormal condition handling concludes at operation 606.

If it is determined at operation 602 that the total number of particles in the histogram is greater than or equal to the first predetermined quantity (e.g., ThreshLow=30), then at operation 608 the computing device may determine whether the total number of particles in the histogram is greater than a second predetermined quantity (i.e., “ThreshHeight”=1000). If the total number of particles (e.g., blobs) in the histogram is greater than the second predetermined quantity (e.g., greater than ThreshHeight=1000), then at operation 610 the computing device may set the Hegman reading to a predetermined default value (e.g., “worstReading”=4). If the total number of particles in the histogram is less than or equal to the second predetermined quantity (e.g., worstReading=1000), as determined at operation 608, then at operation 612 the computing device may communicate to the output device that a Hegman reading cannot be determined. Handling of the abnormal condition may then conclude at operation 606.

After the Hegman readings for the first channel are completed at operation 412 (see FIG. 7c), the method determines at operation 308 (see FIG. 7b) whether additional channels exist for processing. Operations 306 and 308 are repeated to process all the channels that require processing in the manner described above. When the check at operation 308 indicates that there are no additional channels to be processed, then at operation 310 the results from the analyses of all of the channels are consolidated and the image processing concludes at operation 312.

The foregoing description of the embodiments and method of the present disclosure has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the present disclosure.

The example embodiments discussed above are not intended to be limiting, and have been provided so that this disclosure will be thorough and will fully convey the scope of the present disclosure to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An apparatus for analyzing a surface, the apparatus comprising:
an image capturing device and a collimated light source supported fixedly relative to each other, the light source configured to direct substantially parallel light rays at the surface at an angle β relative to the surface, which are reflected off of the surface as reflected light rays, as the image capturing device and collimated light source are moved relative to the surface;
the image capturing device having a view axis disposed at an angle α relative to the surface, and the image capturing device being operative to capture substantially only those ones of the reflected light rays that are reflected in accordance with the angle α, which thus form an image; and
wherein the image provides an indication of a characteristic of the surface.

2. The apparatus of claim 1, wherein the characteristic of the surface represents a gradient of the surface.

3. The apparatus of claim 1, further comprising a processing system for analyzing the image against a predetermined intensity band or intensity range, and detecting variations in the image indicative of at least one of bumps, pits, cracks, elevated ridges, contaminants or other features which may be present on or in the surface.

4. The apparatus of claim 1, wherein the surface comprises a composition having particles therein, and the characteristic comprises a fineness of grind of the particles.

5. The apparatus of claim 2, wherein the image is used to at least one of:
determine the location of the particles on an underlying grind gauge, and from the location, a size of the particles can be inferred; and
differentiate a plurality of features present in the image based on particle size and a two dimensional intensity profile of the image, to thus enable only a count of the particles to be used in constructing a histogram.

6. The apparatus of claim 1, wherein the surface comprises a composition having particles dispersed therein, and wherein the composition is supported on a Hegman guide, and wherein the characteristic comprises a fineness of grind of the particles in the composition, and wherein the fineness of grind is provided as a Hegman reading.

7. An apparatus for analyzing a distribution of particles contained in a composition the apparatus comprising:
a body having a working surface upon which the composition to be analyzed is applied; and
a moveable frame-like structure including an image capturing device and a light source for reflecting light off of the composition, wherein the image capturing device includes a view axis disposed at an angle α relative to the working surface and the light source is operative to produce an image from light reflected off of the composition, the image including a plurality of substantially parallel light rays disposed at an angle β relative to the working surface, which is useable to create a histogram of a fineness of grind of the composition.

8. The apparatus of claim 7, further comprising a computing device configured to analyze the histogram to help determine the granularity of the composition.

9. The apparatus of claim 7, wherein the angle α is between 60 degrees and 89 degrees when measured with respect to the working surface.

10. The apparatus of claim 7, wherein the angle β is between 60 degrees and 89 degrees when measured with respect to the working surface.

11. The apparatus of claim 7, wherein the angle α is substantially equal to 19.2 degrees.

12. The apparatus of claim 7, wherein the difference in magnitude between the angle α and the angle β is between 0.5 and 10 degrees

13. The apparatus of claim 7, wherein the image capturing device is operable to capture a substantially one dimensional image.

14. The apparatus of claim 7, wherein the image capturing device comprises a line scan camera.

15. The apparatus of claim 7, wherein the body is a planar gauge block.

16. The apparatus of claim 15, wherein a working surface of the planar gauge block includes at least one channel formed therein.

17. The apparatus of claim 16, wherein the working surface includes two channels.

18. The apparatus of claim 7, further comprising a holder having a blade portion, wherein the frame-like structure is operable to move the holder from a first position to a second position such that the blade portion is moved over the composition as the holder moves between the first and second positions.

19. The apparatus of claim 7, wherein the light source comprises a collimated light source.

20. A method of analyzing a surface, the method comprising:
moving an image capturing device having a collimated light source from a first position to a second position, at an angle β relative to the surface, to illuminate the surface with a plurality of parallel light rays;
simultaneously moving an image capturing device, arranged with a view angle α which is different from the angle β, over the surface to capture only light rays which are reflected from the surface in accordance with angle α, the light rays forming an image; and
using the image to analyze a characteristic of the surface.
